(19) United States
(12) Patent Application Publication
(10) Pub. No.: US 2008/0198814 A1
(43) Pub. Date: Aug. 21, 2008

(54) Mapping Of Shared Physical Channels Depending On The Quality Of Service Class

(75) Inventors: Christian Wengerter, Kleinheubach (DE); Eiko Seidel, Darmstadt (DE)

Correspondence Address: DICKINSON WRIGHT PLLC, 1901 L STREET NW, SUITE 800, WASHINGTON, DC, 20036, US

(73) Assignee: Matsushita Electric Industrial Co., Ltd., Osaka (JP)

(21) Appl. No.: 11/628,044

(22) PCT Filed: Dec. 3, 2004
(86) PCT No.: PCT/EP2004/013777

§ 371 Date: Sep. 24, 2007

(30) Foreign Application Priority Data
Jun. 8, 2004 (EP) 04013494.2

(51) Int. Cl. H04L 12/56; H04J 3/02

(52) U.S. Cl. 370/336

(57) ABSTRACT

A method, a base station and a wireless communication system are provided which allow to provide optimized Quality of Service to each of a plurality of services belonging to different QoS classes and different users, transmitted over shared physical channels. Data packets are assigned to service categories. To each service category only packets are assigned exclusively belonging to services associated with one user or user group and exclusively belonging to one of said Quality of Service classes. Based on information about the packets, the service categories and/or the shared physical channels, scheduling metrics are calculated, based upon the scheduling metrics, it is decided which of said service categories is to be served next.

### BACKGROUND OF THE INVENTION

1. Field of the Invention

This invention relates to wireless communication systems employing dynamic resource allocation schemes (Dynamic Channel Allocation, DCA) together with Link Adaptation (LA) schemes when services with different Quality of Service (QoS) requirements are supported.

In particular, this invention relates to methods for multiplexing user data to the physical layer in wireless communication systems with Dynamic Channel Allocation (DCA) and Link Adaptation (LA) techniques, and to a method for adapting transmission parameters of the physical channel efficiently to the Quality of Service (QoS) requirements of the different services and applications of different users.

The description will in the following concentrate on the downlink transmission.

2. Description of the Related Art

In wireless communication systems employing Dynamic Channel Allocation (DCA) schemes, air interface resources are assigned dynamically to different mobile stations. See for example R. van Nee, R. Prasad, “OFDM for Wireless Multimedia Communications”, Artech House, ISBN 0-89006-530-6, 2000 and H. Rohling and R. Grunheid, “Performance of an OFDM-TDMA mobile communication system,” in Proc. IEEE Vehicular Technology Conf. (VTC'96), Atlanta, Ga., pp. 1589-1593, 1996. Air-interface resources are usually defined by physical channels (PHY channels). A physical channel corresponds to e.g. one or multiple bundled codes in a Code Division Multiple Access (CDMA) system, one or multiple bundled sub-carriers (sub-carrier blocks) in an Orthogonal Frequency Division Multiplex Access (OFDMA) system or to combinations of those in an Orthogonal Frequency Code Division Multiplex Access (OFCDMA) or an Multi Carrier-Code Division Multiple Access (MC-CDMA) system. In case of DCA, a PHY Channel is called shared physical channel.

FIG. 1 and FIG. 2 show DCA schemes for systems with a single and multiple shared physical channels respectively. A physical frame (PHY frame) reflects the time unit for which a so-called scheduler (PHY Scheduler) performs the DCA.

FIG. 1 illustrates a structure where data for four mobile stations is transmitted over one shared physical channel 102. The time axis is represented by arrow 101. Boxes 103 to 108 represent PHY frames, wherein, as an illustrative example, frame 106 carries data for a first mobile station, frame 103 carries data for a second mobile station, frames 104 and 108 carry data for a third mobile station and frames 105 and 107 carry data for a fourth mobile station. In this example, a frequency or code division duplex system is shown, where one resource (i.e. frequency band or code) is continuously available for the depicted shared physical channel. In case of TDD, where an uplink PHY channel and a downlink PHY channel share one frequency or code, there would be gaps between the frames or within the frames of one channel corresponding to the duration of the transmission of a channel in the opposite direction. For this case, all description below would likewise be applicable as well.

FIG. 2 illustrates the case where N shared physical channels 202 to 205 transmit data designated to four mobile stations. Arrow 201 represents the time axis. Columns 230 to 235 represent the time units of PHY frames for all channels. Boxes 206 to 229 represent data units defined by PHY channels and PHY frames. For example, data in boxes 206 to 211 is transmitted over PHY channel 1 and data in boxes 206, 212, 218 and 224 is transmitted during frame 230. In the given example, the data units 208, 212, 220, 221, 223, 225 and 227 carry data for a first mobile station, 206, 207, 215, 217, 226 and 228 carry data for a second mobile station, 209, 210, 224 and 229 carry data for a third mobile station and 211, 213, 214, 216, 218, 219 and 222 carry data for a fourth mobile station.

In order to utilize the benefits from DCA, it is usually combined with Link Adaptation (LA) techniques such as Adaptive Modulation and Coding (AMC) and Hybrid Automatic Repeat reQuest (HARQ).

In a wireless communication system employing Adaptive Modulation and Coding (AMC), the data-rate within a PHY frame for a scheduled user will be adapted dynamically to the instantaneous channel quality of the respective link by changing the Modulation and Coding Scheme (MCS). This requires a channel quality estimate to be available at the transmitter for the link to the respective receiver. Detailed description of AMC is available in van Nee and Prasad cited above, Rohling and Grunheid cited above, as well as 3GPP, Technical Specification 25.308; High Speed Downlink Packet Access (HSDPA); Overall description; Stage 2, v. 5.3.0, December 2002, A. Burr, “Modulation and Coding for Wireless Communications”, Pearson Education, Prentice Hall, ISBN 0-201-39857-5, 2001, L. Hanzo, W. Webb, T. Keller, “Single- and Multi-carrier Quadrature Amplitude Modulation”, Wiley, ISBN 0-471-49239-6, 2000, A. Czylwik, “Adaptive OFDM for wideband radio channels,” in Proc. IEEE Global Telecommunications Conf. (GLOBECOM'96), London, U.K., pp. 713-718, November 1996 and C. Y. Wong, R. S. Cheng, K. B. Letaief, and R. D. Murch “Multiuser OFDM with Adaptive Subcarrier, Bit, and Power Allocation,” IEEE J. Select. Areas Commun., vol. 17, no. 10, October 1999.

For a given channel quality, different selected MCS levels corresponding to different data rates result in different PHY frame error rates. Systems are typically operated at PHY frame error rates (after the first transmission) between 1% and 30%. The so-called MCS “aggressiveness” is a common term to specify this MCS property. The MCS selection is considered to be “aggressive” if the target PHY frame error rate (after the first transmission) is high, i.e. for a given channel estimation a high MCS level is chosen. This “aggressive” MCS selection behaviour can be useful when e.g. the transmitter assumes that the channel estimation is inaccurate or when a high packet loss rate is tolerable.

Due to the PHY frame error rates caused by the selection of the MCS level (e.g. by incorrect channel quality estimation or inherent to the selected MCS level for a given channel quality), Hybrid Automatic Repeat reQuest (HARQ) schemes are used to control the data or packet loss rate (i.e. residual PHY frame error rate after retransmissions) delivered to the next layer or to the service/application. If a data block is received with uncorrectable errors, the data receiver transmits a NACK (“Not ACKnowledge”) signal back to the transmitter, which in turn, re-transmits the data block or transmits additional redundant data for it. If a data block contains no errors or only correctable errors, the data receiver responds with an ACK (“ACKnowledge”) message. Details are explained in Rohling and Grunheid cited above as well as S. Kallel, “Analysis of a type II hybrid ARQ scheme with code combining,” IEEE Transactions on Communications, Vol. 38, No. 8, August 1990, S. Lin, D. J. Costello Jr., “Error Control Coding: Fundamentals and Applications”, Prentice-Hall, 1983 and S. Lin, D. J. Costello, M. J. Miller, “Automatic-repeat-request error-control schemes,” IEEE Commun. Mag., vol. 22, no. 12, pp. 5-17, December 1984. As explained in the following, this residual PHY error rate depends as well on the AMC operation as on the HARQ operation.

As mentioned above, the AMC operation influences the residual PHY error rate by its so-called “aggressiveness”. For a given HARQ setting an “aggressive” MCS selection will result in an increased residual PHY error rate, but yields the potential of improved throughput performance. A “conservative” MCS selection will result in a reduced residual PHY error rate.

The HARQ operation influences the residual PHY error rate by the number of maximum HARQ retransmissions and the employed HARQ scheme. Examples of well-known HARQ schemes are Chase Combining and Incremental Redundancy. The HARQ scheme specifies the method employed for the re-transmission of data packets received with uncorrectable errors. With Chase Combining, for example, the packet in question is re-transmitted unchanged, and the received data is combined with data from previous transmissions to improve the signal to noise ratio. With incremental redundancy, each re-transmission contains additional redundant data to allow improved error correction. For a given number of maximum retransmissions an Incremental Redundancy scheme will decrease the residual PHY error rate and the delay compared to e.g. Chase Combining, at the expense of higher complexity. Moreover, for a given MCS “aggressiveness” an increase of the number of maximum HARQ retransmissions decreases the residual PHY frame error-rate, but also increases the delay.

In a system, which makes use of DCA, AMC and HARQ, a so-called PHY scheduler decides which resources are assigned to which mobile station. A commonly used approach is to use centralized scheduling, where the scheduler is located in the base station and performs its decision based on the channel quality information of the links to the mobile stations, and according to the traffic occurring on those links, e.g. amount of data to be transmitted to a specific mobile station.

Common objectives of the PHY scheduler are to achieve fairness between users and/or to maximize system throughput.

In state-of-the-art wireless communication systems the MAC/PHY scheduler works on a packet basis, i.e. the data arriving from higher layers is usually treated packet-by-packet at the scheduler. Those packets may then be segmented or/and concatenated in order to fit them into a PHY frame with the selected MCS level.

The following schedulers are well known in the area of wireless communications:

Round Robin (RR) Scheduler:

This scheduler allocates equal air-interface resources to all users independent of the channel conditions thus achieving fair sharing of resources between users.

Max-Rate (MR) or Max C/I (MC) Scheduler:

This scheduler chooses the user with the highest possible instantaneous data-rate (carrier-to-interference C/I ratio). It achieves the maximum system throughout but ignores the fairness between users.

Proportional Fair (PF) Scheduler (see e.g. J. M. Holzman, “Asymptotic analysis of proportional fair algorithm,” Proc. IEEE PIMRC 2001, San Diego, Calif., pp. F-33-F-37, October 2001):

This scheduler maintains an average data-rate transmitted to each user within a defined time window and examines the ratio of the instantaneous to the average channel conditions (or ratio of the instantaneous possible data-rate to the average data-rate) experienced by different users and chooses the user with the maximum ratio. This scheduler increases the system throughput with respect to RR scheduling, while maintaining long-term fairness between users.

In several state-of-the-art communication systems services/applications are categorized according to QoS classes. Services belonging to the same QoS class have similar QoS requirements, such as delay, loss rate, minimum throughput, etc. Note, that the granularity of the QoS class definition can vary between different systems. Examples for QoS class definitions are shown in Table 1 for UMTS (see 3GPP TSG RAN TR 23.107: “Quality of Service (QoS) concept and architecture”. V5.12.0, http://www.3gpp.org) and in Table 2 for ATM.

TABLE 1
UMTS traffic/QoS classes.

| | Conversational | | | Background |
|---|---|---|---|---|
| Traffic Class | class | Streaming class | Interactive class | Background best |
| QoS Class | conversational RT | streaming RT | Interactive best effort | effort |
| Fundamental | Preserve time | Preserve time relation | Request response | Destination is not |
| characteristics | relation (variation) | (variation) between | pattern | expecting the data |
| | between information | information entities of | Preserve payload | within a certain time |
| | entities of the stream | the stream | content | Preserve payload |
| | Conversational | | | content |
| | pattern (stringent | | | |
| | and low delay) | | | |
| Example of the | voice | streaming video | Web browsing | background download |
| application | | | | of emails |

TABLE 2
ATM service/QoS classes.

| Service | | | | | |
|---|---|---|---|---|---|
| Class | | variable bit rate- | variable bit rate- | | available |
| QoS | constant bit rate | non-real time | non-real time | | bit rate |
| Class | (CBR) | (VBR-NRT) | (VBR-NRT) | available bit rate (ABR) | (ABR) |
| Quality of | This class is used | This class allows | This class is | This class of ATM services | This |
| Service | for emulating | users to send | similar to VBR- | provides rate-based flow control | class is |
| (QoS) | circuit switching. | traffic at a rate that | NRT but is | and is aimed at data traffic such | the |
| Parameter | The cell rate is | varies with time | designed for | as file transfer and e-mail. | catch-all, |
| | constant with time. | depending on the | applications that | Although the standard does not | other |
| | CBR applications | availability of user | are sensitive to | require the cell transfer delay | class and |
| | are quite sensitive | information. | cell-delay | and cell-loss ratio to be | is widely |
| | to cell-delay | Statistical | variation. | guaranteed or minimized, it is | used |
| | variation. | multiplexing is | Examples for real- | desirable for switches to | today for |
| | Examples of | provided to make | time VBR are | minimize delay and loss as | TCP/IP. |
| | applications that | optimum use of | voice with speech | much as possible. Depending | |
| | can use CBR are | network | activity detection | upon the state of congestion in | |
| | telephone traffic | resources. | (SAD) and | the network, the source is | |
| | (i.e., nx64 kbps), | Multimedia e-mail | interactive | required to control its rate. The | |
| | videoconferencing, | is an example of | compressed | users are allowed to declare a | |
| | and television. | VBR-NRT. | video. | minimum cell rate, which is | |
| | | | | guaranteed to the connection by | |
| | | | | the network. | |

In state-of-the-art wireless communication systems a mobile station can run several services belonging to different QoS classes at a time. Typically, those services (QoS classes) have different QoS requirements as e.g. shown in Table 3.

TABLE 3
Typical applications/services and respective QoS requirements.

| Typical | Data Rate | | Delay Bound | Packet Loss |
|---|---|---|---|---|
| Applications/Services | (bps) | | (ms) | Rate |
| Voice | 32k-2 | M | 30-60 | 10⁻² |
| Video streaming | 1-10 | M | Large | 10⁻⁶ |
| Videoconference | 128k-6 | M | 40-90 | 10⁻³ |
| File transfer | 1-10 | M | Large | 10⁻⁸ |
| Web browsing | 1-10 | M | Large | 10⁻⁸ |

In FIG. 3 an example of a simplified transmitter architecture is shown, with a focus on the service QoS/priority scheduling and the MAC/physical layer units. In this example, two mobile stations share the air interface resources (for example 8 shared physical channels as shown in FIG. 4), and each of the mobile stations is running simultaneously three services belonging to different QoS classes, namely 303-305 running on a first mobile station and 306-308 running on a second mobile station. Table 4 shows the association of user services to QoS classes for the example illustrated in FIG. 3. Services 303, 304 and 307 belong in this example to QoS class 2, service 305 belongs to QoS class 1 and services 306 and 308 belong to QoS class 3.

TABLE 4
QoS class association of user services shown in FIG. 3.

| QoS class | User U₁ | User U₂ |
|---|---|---|
| 1 | S₃ (305) | — |
| 2 | S₁ (303), S₂ (304) | S₂ (307) |
| 3 | — | S₁ (306), S₃ (308) |

The packets from the service packet queues will be treated in the QoS/Priority Scheduler unit 309 in order to account for the QoS and the priorities of the respective packets originating from different services. The interface of the QoS/Priority Scheduler unit 309 to the Packet Multiplexing unit 310 depends on the employed QoS/Priority Scheduler algorithm. This interface might be a single queue holding packets from all users and all services; it might be a single queue per user containing packets from all services per user; it might be one queue per defined QoS class, etc.

The sorted packets (in one or multiple queues) are passed to the Packet Multiplexing unit 310, where packets are concatenated or segmented and coded into PHY Data Blocks in order to fit into the resources and data rates assigned by the PHY Scheduler & Link Adaptation unit 311. Each PHY Data Block has own parity data, and in case of uncorrectable errors the whole block has to be re-transmitted. Depending on the architecture, there might also be an entity assigning data blocks to one or multiple configured HARQ processes as e.g. in 3GPP HSDPA (3GPP TSG RAN TR 25.308: “High Speed Downlink Packet Access (HSDPA): Overall Description Stage 2”. V5.2.0, http://www.3gpp.org).

Interaction is necessary between the Packet Multiplexing 310 and the PHY Scheduler & Link Adaptation unit 311 in order to fit the size of the multiplexed packets to the allocated resources on the shared physical channels for the scheduled users. Moreover, the QoS/Priority Scheduler 309 and the PHY Scheduler 312 may interact in order to align their objectives or they may be even implemented in a single entity. As the smallest time unit for HARQ Protocol Handling and Link Adaptation within one shared PHY channel is one frame, and each frame is assigned to one user only, the interaction indicated with arrows 314-316 is to be understood on a “per user” basis.

As a result of this architecture, the Packet Multiplexing unit 310 may multiplex for each PHY frame packets from different services running on the same mobile station. The Packet Multiplexing unit 310 will then either generate a single or multiple PHY Data Blocks per mobile station, which will then be mapped on the shared physical channels allocated to a specific user.

FIG. 4 illustrates the mapping of the packets from services 303-308 in the architecture shown in FIG. 3 onto the different shared physical channels 401-408 within one frame 400. In this example the data rate chosen by the MCS selection is exemplified by the number of multiplexed packets per shared physical channel shown. PHY channels 401, 402, 404, 406 and 408 carry data for services 303-305 of the first mobile station, channels 403, 405 and 407 carry data for services 306-308 of the second mobile station.

In the following cases it can happen that packets from different QoS classes are mapped onto the same PHY Data Block or shared physical channel (herein below explained for the QoS class association shown in FIG. 3 and table 4):
A single PHY Data Block containing packets from different QoS classes is mapped onto one shared physical channel, e.g. shared physical channel 407 in FIG. 4.
A single PHY Data Block containing packets from different QoS classes is mapped onto multiple shared physical channels, e.g. physical channels 404+408 in FIG. 4.
Multiple PHY Data Blocks with at least one PHY Data Block containing packets from different QoS classes are mapped onto a single shared physical channel, e.g. shared physical channel 405 in FIG. 4.
Multiple PHY Data Blocks with at least one PHY Data Block containing packets from different QoS classes are mapped across multiple shared physical channels, e.g. shared physical channels 401+402 in FIG. 4.

In case of the mapping of multiple PHY Data Blocks across multiple shared physical channels (e.g. shared physical channels 401+402), FIG. 4 suggests that a single packet of a PHY Data Block is assigned clearly to a single shared physical channel. This will not be the case in most state-of-the-art systems, since channel interleaving is usually employed, which yields a distribution of the packets over all shared physical channels on which the PHY Data Block is mapped. The interleaving occurs when the data packets are mapped into one data block and the data block is coded. When the data block is segmented again and mapped onto different channels, each data packet is usually distributed over all block segments and therefore over multiple channels.

One important requirement to a modern communication system is that a user or mobile station can run multiple services belonging to different QoS classes at a time. In prior art systems the QoS cannot be controlled or influenced on a QoS class basis at the PHY Scheduler & Link Adaptation unit, since packets from different QoS classes may be mapped onto the same shared physical channel.

### SUMMARY OF THE INVENTION

It is an object of the present invention to provide optimized Quality of Service to each of a plurality of services belonging to different Quality of Service classes and to different users, while at the same time making most efficient use of the existing transmission capacity.

This object is achieved by a method, a base station and a wireless communication system according to the independent claims. Advantageous embodiments are described in the dependent claims.

According to a first embodiment of the invention a method for optimizing a quality of service in a wireless communication system transmitting data packets in time intervals of frames over at least one shared physical channel, wherein services are categorized into Quality of Service classes according to Quality of Service requirements associated with said services, and said data packets are assigned to service categories, wherein to at least a part of the service categories only packets are assigned exclusively belonging to services associated with one user or user group and exclusively belonging to one of said Quality of Service classes, comprises the steps of:

a) calculating scheduling metrics, based on information about said packets, said service categories and/or said at least one shared physical channel; and

b) deciding, based upon the scheduling metrics, which of said service categories is to be served next and deciding, based upon the scheduling metrics, about a mapping of service categories to shared physical channels.

The method may further comprise a step c) of calculating priority values for at least a part of the service categories as basis for said scheduling metrics.

The method may further comprise a step d) of calculating potential data rate values for at least a part of the combinations of service category and shared physical channel, wherein step c) is based on results of step d).

The method may further comprise a step e) of determining virtual link adaptation parameters as basis for step d).

The method may further comprise a step of multiplexing packets into queues according to the service categories to which they are assigned.

According to another embodiment of the invention a computer-readable storage medium has stored thereon instructions that, when executed in a processor of a base station of a wireless communication system, causes the processor to perform the method of the first embodiment.

According to a further embodiment a base station for a wireless communication system comprises a network interface, connecting it to a core network of said wireless communication system; wireless transmission means; and a processor for controlling said transmission means, and for transmitting data packets in time intervals of frames over at least one shared physical channel of said transmission means, wherein services are categorized into Quality of Service classes according to quality of service requirements associated with said services, and said data packets are assigned to service categories, wherein to at least a part of the service categories only packets are assigned exclusively belonging to services associated with one user or user group and exclusively belonging to one of said Quality of Service classes, wherein said processor is configured:

to calculate scheduling metrics, based on information about said packets, said service categories and/or said at least one shared physical channel; and

to decide, based upon the scheduling metrics, which of said service categories is to be served next.

According to another embodiment of the present invention, a wireless communication system comprises at least one base station according to the preceding embodiment.

### BRIEF DESCRIPTION OF THE DRAWINGS

The accompanying drawings are incorporated into and form a part of the specification for the purpose of explaining the principles of the invention. The drawings are not to be understood as limiting the invention to only the illustrated and described examples of how the invention can be made and used. Further features and advantages will become apparent from the following and more particular description of the invention, as illustrated in the accompanying drawings, wherein

FIG. 1 shows an example for DCA with multiplexing four mobile stations on a single shared physical channel according to prior art.

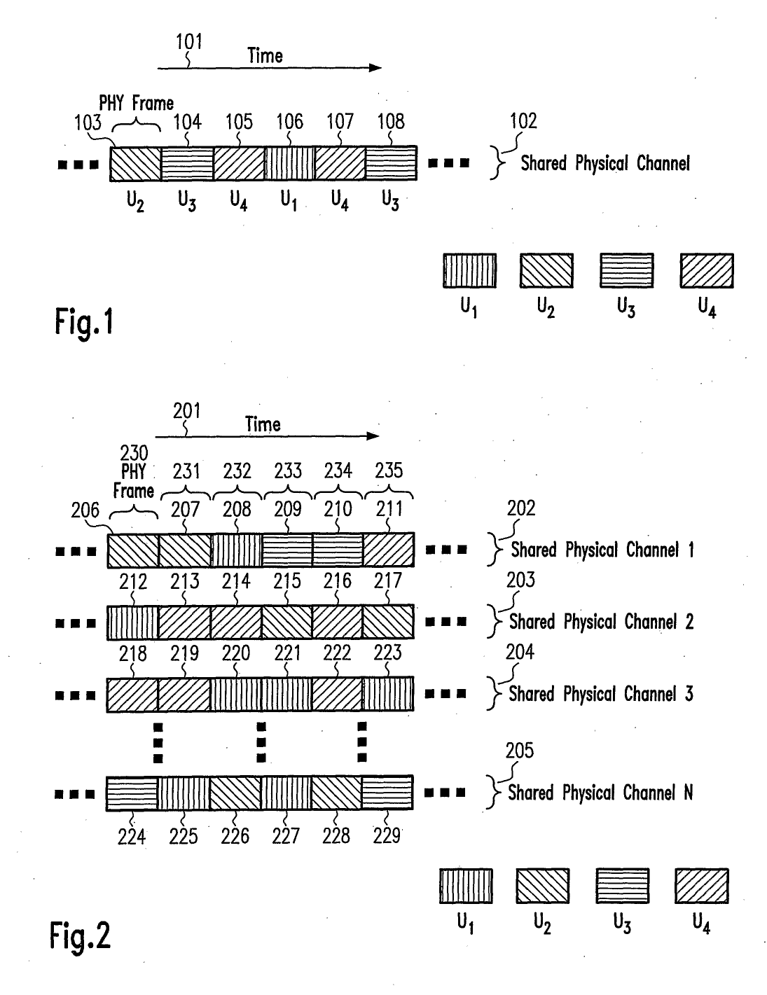

FIG. 2 illustrates an example for DCA with multiplexing four mobile stations on multiple (N) parallel shared physical channels according to prior art.

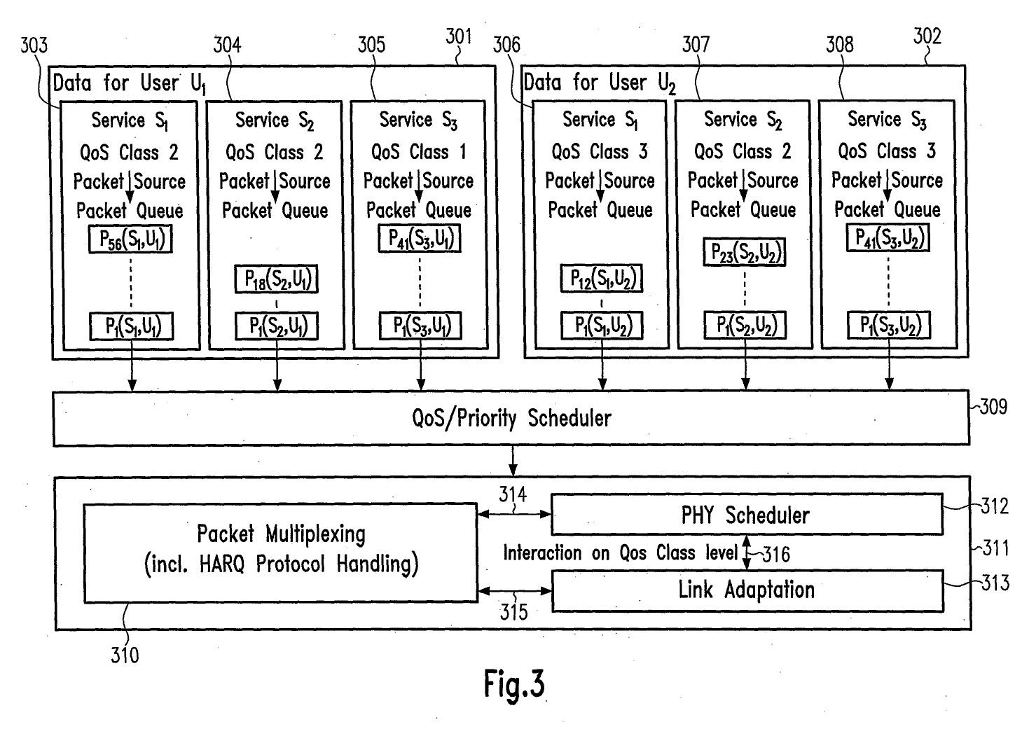

FIG. 3 depicts a simplified general transmitter architecture for mapping service data to shared physical channels.

FIG. 4 shows an exemplary mapping of data blocks onto eight shared physical channels within one frame, achieved by the system shown in FIG. 3.

FIG. 5 illustrates one frame within eight shared physical channels, each channel containing only packets from services belonging to the same QoS class within this frame. Each PHY channel contains one PHY data block.

FIG. 6 illustrates the mapping of service data to eight shared physical channels for a single PHY frame.

FIG. 7 depicts an exemplary mapping result with segmented packets.

FIG. 8 illustrates a schematic of a system, in which the service specific MCS and HARQ parameter selection is adapted to the actual QoS status of the packets.

FIGS. 9 a and b show the structure of a data processing system which enables scheduling, physical channel mapping and link adaptation depending on the Quality of Service requirements of the transmitted data.

FIGS. 10-12 depict alternative possibilities for the data packet buffer structure shown in FIG. 9.

FIG. 13 is a flowchart showing the steps carried out in the structure of FIGS. 9-12.

FIG. 14 illustrates the structure of a base station in which the method described above can be utilized.

### DETAILED DESCRIPTION OF THE INVENTION

The exemplary embodiments of the present invention will be described with reference to the figure drawings wherein like elements and structures are indicated by like reference numbers.

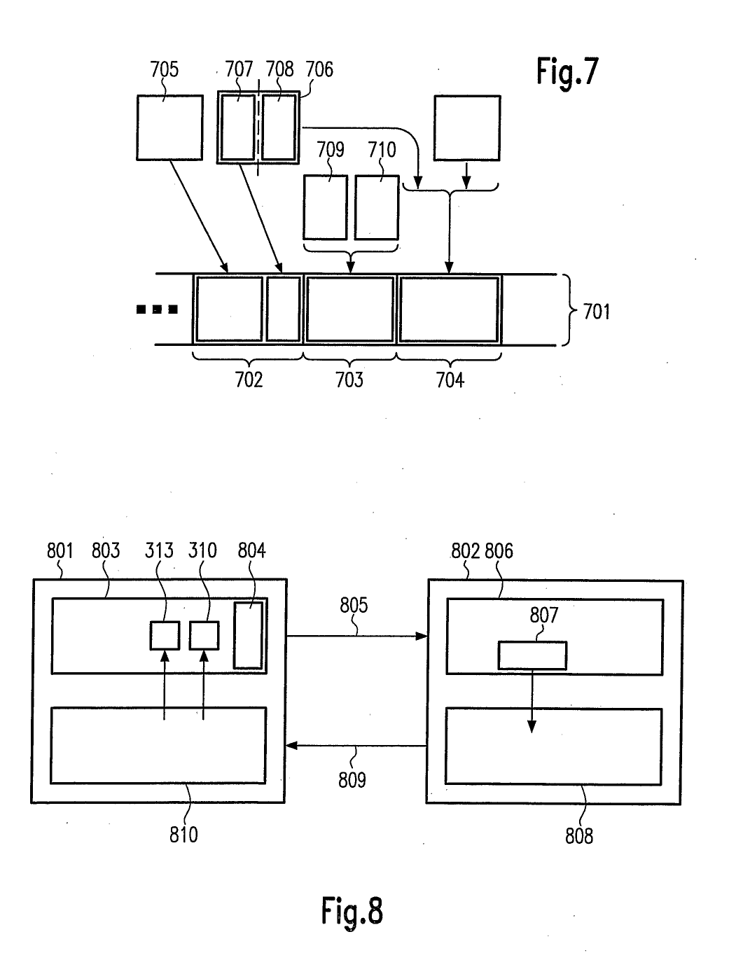

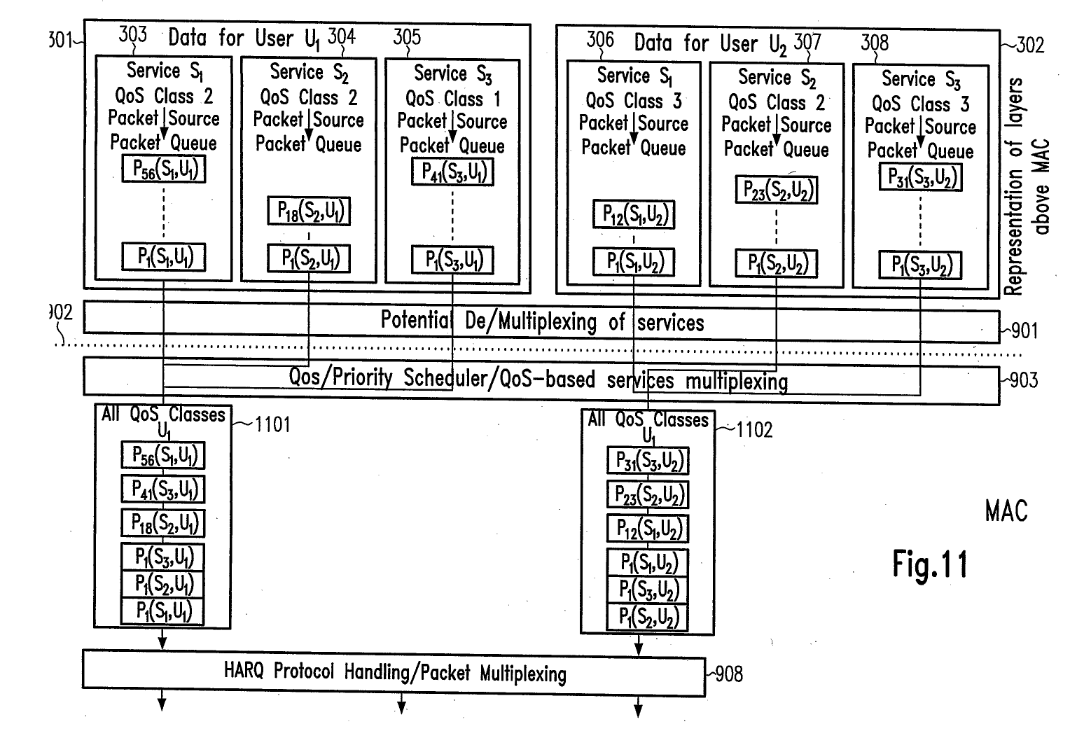

Referring first to FIGS. 9 a and b and FIG. 5, a method is shown how data packets 509-516 from services 303-305 running on a first mobile station and services 306-308 running on a second mobile station are mapped to PHY channels 501-508 in a way that allows individual adaptation of transmission parameters of the PHY channels 501-508 to the QoS requirements of the QoS classes, to which services 303-308 belong. Transmission parameters should be understood in this context as physical layer parameters and coding parameters influencing the transmission quality of the PHY Channel, comprising transmission power, MCS selection, forward error correction scheme, HARQ scheme, maximum number of re-transmissions and so on. Although even transmission parameters of a single shared physical channel may be adapted to QoS requirements, there will be more than one shared physical channel in the general case. Within the same PHY frame 500, each PHY Data Block (one per PHY channel) contains only data packets from services belonging to the same QoS class. For example, PHY Data Block 511 (channel 501) contains only packets 509 belonging to service 303 and data packets 510 of service 304. Both services are running on the first mobile station 301 and belong to QoS class 2.

Firstly, in De-/Multiplexing unit 901, data packets for different services arriving on the same path may be demultiplexed and data packets for the same service arriving over different paths may be multiplexed, such that the packets are handed from higher layers to the MAC layer sorted by services. In another alternative, some services having an identical QoS class could be handed to the MAC layer in multiplexed state. The boundary between higher layers like layer 2 and the MAC layer is symbolized by dotted line 902.

For each data packet, information is available about a QoS class to which the service belongs to, for which the packet carries data. Furthermore a user, a user group (in the case of broadcast or multicast services) or a receiving device can be determined, who runs the service. This information may be comprised within the packet or separately signalled in a control plane of the transmission protocol. Consequently, it is possible to categorize services and data packets carrying data belonging to a specific service into service categories, where one service category holds only packets belonging to one user and one QoS class.

In the example of FIG. 9, QoS/priority scheduler 903 multiplexes exclusively packets of one service category only into each of the queues 904 to 907. This allows a simple access to the packet related information for the DRC calculation unit 912 and the priority calculation unit 911 and a simple FIFO (“first in first out”) buffer functionality, as HARQ protocol handling/packet multiplexing unit 908 may always take the packet first, which has first entered the queue of the selected service category.

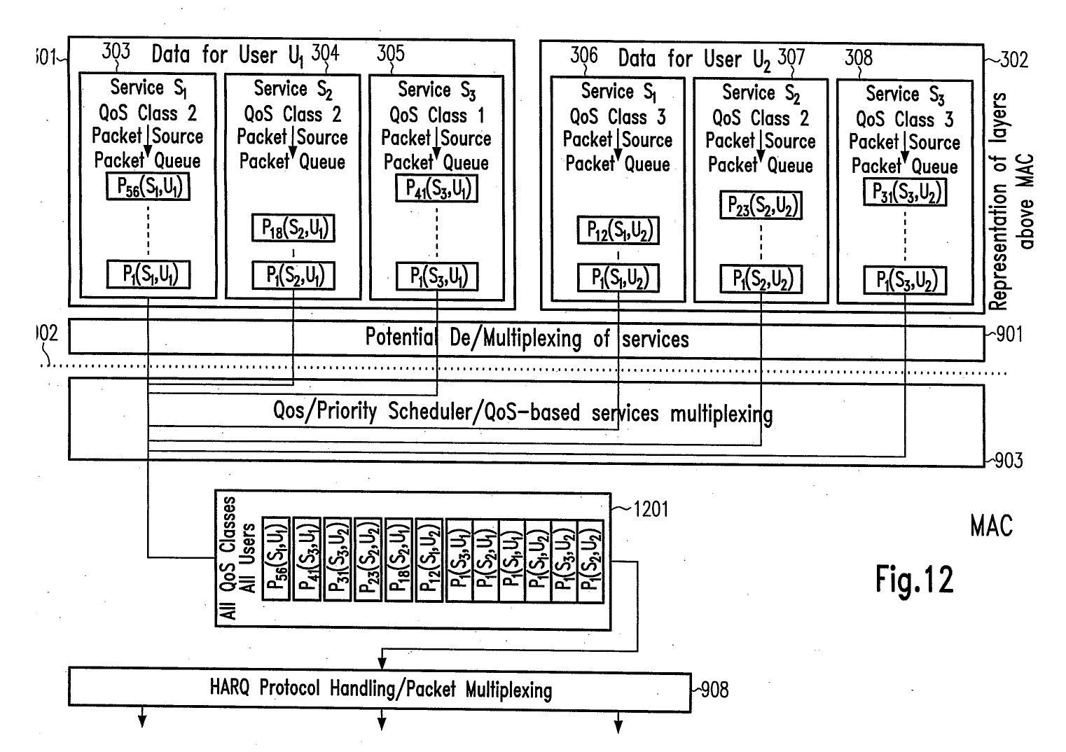

Other alternatives of the present invention, shown in FIGS. 10-12, use one packet buffer per QoS class for all users together, one buffer per user for all QoS classes or one buffer for all packets. In FIG. 10, buffers 1001 to 1003 each contain packets exclusively belonging to services of one QoS class only. However, each buffer may contain packets for services run by different users. For example, buffer 1002 contains packets P₁(S₁, U₁) and P₅₆(S₁, U₁) of service S₁ (303) run by user U₁ (301) and packets P₁(S₂, U₂) and P₁₈(S₂, U₂) of service S₂ (307) run by user U₂ (302). In FIG. 11, buffers 1101 and 1102 contain packets from services belonging to different QoS classes. However, each buffer exclusively contains packets of services all run by the same user. In FIG. 12, there is one common packet buffer 1201 for all packets to be scheduled, irrespective of QoS class or user to which they are associated.

In the cases of FIGS. 10-12, units 908, 911 and 912 need to have selective (random) access to the packets in the buffers, since those units need information per QoS class per user, i.e. per service category. Furthermore it is not possible in this case to always schedule packets in the order as they have entered the buffer.

As a basis for scheduling metrics, DRC calculation unit 912 calculates information about potential data rates for at least some of the combinations of service category and physical channel. The calculation of these values is based on information about states of the physical channels (e.g. signal to noise ratio, transmission loss etc.) (arrow 917) and on the buffer status of the QoS class queues (arrow 914), where the buffer status may set an upper limit of the potential data rate which can be obtained from the physical channels, in the case that there is not enough data in a buffer to fill a complete frame at the given physical data rate. The state information or channel quality information about the physical channels may be received from the receivers of the data, that is the mobile stations of users U₁ and U₂, or may be measured by the transmitter by channel estimation. Advantageously, for each combination of physical channel and service category an achievable data rate is calculated.

As the achievable data rate depends on the parameters of the transmission, like forward error correction coding rate and scheme, modulation scheme, power control, HARQ scheme, redundancy version selection etc, it is necessary to make assumptions on these values as an input for the calculation of the data rate. Therefore DRC calculation unit 912 also decides these assumptions, which is called herein “virtual link adaptation” due to its speculative nature. All DRC information may be handed to MAC/PHY scheduler 909 directly (arrow 919) and/or handed to priority value calculation unit 911 (arrow 915).

The data rate information is used for the PHY data block formation in the packet multiplexing unit 908 (arrow 916), as it determines which amount of data of a given service category can be transmitted within one PHY frame on a given shared physical channel. The same way, information about an appropriate HARQ scheme may be informed to the HARQ protocol handling unit.

As a basis for scheduling metrics, MAC/PHY scheduler & PCH mapping unit 909 receives priority information for each combination of physical channel 501-508 and service category from priority calculation unit 911. Such a priority calculation may be based on the difference of a time when delivery of the data within the buffer and belonging to the service category is due, minus the actual time (“time to live”) or based on a ratio between desired transmission data rate and actual transmission rate in the recent past. In the case that the priority calculation is based on a property which may be different for different data packets within one service category, the worst value of all buffered packets within a category may be determined and used for the calculation of the priority value.

The priority values may also depend on the input from the DRC calculation unit 912. They may be calculated using the same algorithm for all QoS classes. Alternatively they may be calculated using different algorithms for different QoS classes, depending on the parameters which are most critical for the respective QoS class. Such parameters may comprise a required or actual data rate, a required or actual packet error rate, or a required or actual packet delay. As another alternative, a fixed value representing a fixed QoS class priority, a service category priority or a user dependent value might be used as priority value or as additional input to the priority value calculation.

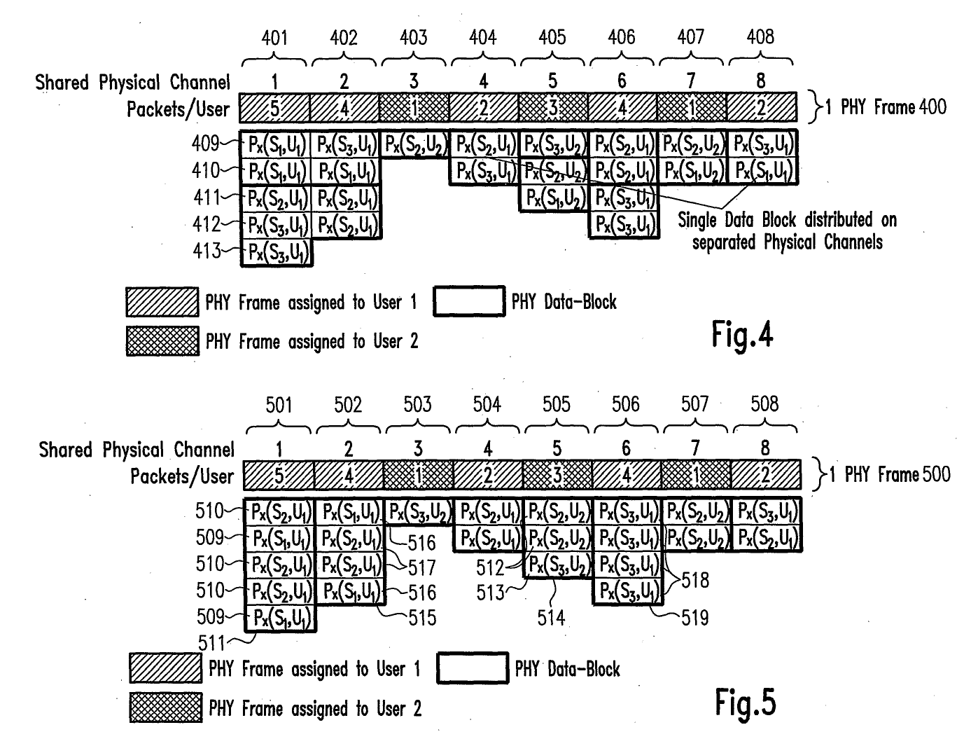

Based on the information input from priority calculation unit 911 and optionally also from DRC calculation unit 912, the scheduler calculates scheduling metrics for each service category and each physical channel, preferably for each frame. Based on the scheduling metrics, it selects service categories (that is, in the alternative of FIG. 3 one of the queues 904-907) to be served and maps data from the selected service category (queue) onto a shared PHY channel. Following the shared channel concept, data from any of the service categories (queues 904-907 in FIG. 3) can be mapped onto any shared PHY channel. However, according to the principle of the present invention, within one PHY frame exclusively data from a single service category is mapped onto one shared PHY channel. This allows link adaptation according to the QoS requirements in PHY processing unit 910, which performs coding and modulation of the data blocks received from MAC/PHY scheduler & PCH mapping unit 909. The scheduling information is passed (arrow 918) to HARQ protocol handler/packet multiplexer 908 to be used for the multiplexing of packets into physical data blocks.

HARQ protocol handling/packet multiplexing unit 908 collects packets to be combined into physical data blocks from the specified service categories (queues 904-907 in FIG. 9). It combines the packets into physical data blocks and controls re-transmission of data based on non-acknowledgement messages (not shown) from the receivers (i.e. the mobile stations of users U₁ and U₂). The combining of packets into data blocks is still performed on a per service category basis.

HARQ protocol handling/packet multiplexing unit 908 passes data blocks on to MAC/PHY scheduler & PCH mapping unit 909. This unit is situated between MAC layer and PHY layer on boundary 913.

Based on the mapping decision, MAC/PHY scheduler & PCH mapping unit 909 passes the scheduled data block to PHY processing unit 910. Unit 910 further receives transmission parameter information for appropriate processing. This may be achieved in different ways, yet leading to the same result that the real data rate of each shared physical channel matches the data rate calculated by the virtual link adaptation as a basis for the scheduling decision.

In one alternative, MAC/PHY scheduler 909 receives this information from unit 912 (arrow 919) and passes it on to PHY processing unit 910 (arrow 920), along with the data blocks. In another alternative, unit 909 hands the scheduling and mapping information to unit 912 (arrow 921), which selects the appropriate link adaptation information and hands it to unit 910 (arrow 922). It would also possible to hand all virtual link adaptation information from DRC calculation unit 912 to PHY processing unit 910, and scheduling information from MAC/PHY scheduler and PCH mapper 909 to PHY processing unit 910, which picks the appropriate link adaptation information from the information received from DRC calculation unit 912, based on the scheduling information received from MAC/PHY scheduler and PCH mapper 909.

Depending on the implementation, units 908-912 may exchange further information as necessary.

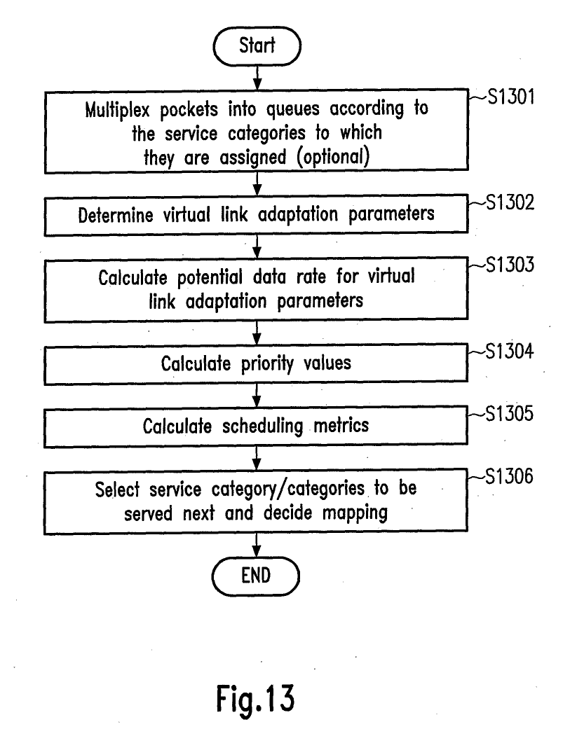

FIG. 13 is a flowchart showing the steps carried out in the method described above. In step S1301, packets may be multiplexed by QoS/priority scheduler 903 into separate queues according to the service categories to which they belong. This step is optional and corresponds to the variant shown in FIG. 9. Referring to this figure, queue 905 contains only packets for user U₁. They belong to services S₁ (303) and S₂ (304) of this user, which both are categorized into QoS class 2.

Referring back to FIG. 13, in step S1302, virtual link adaptation parameters are determined for at least some of the combinations of service category and shared physical channel. Virtual link adaptation parameters are transmission parameters which would be used to transmit data belonging to the respective service category on the respective shared physical channel. These parameters may comprise one or more of: forward error correction rate and scheme, modulation scheme, power control parameters, HARQ scheme and redundancy version. These parameters may be determined depending on channel quality information. This channel quality information may comprise reception field strength, transmission loss or signal to noise ratio on the receiver side. The virtual link adaptation parameters are optimized with respect to the QoS class to which the service category in question belongs. In one alternative, this channel quality information is reported by a recipient of data which has been transmitted on the respective channel.

Next, in step S1303 potential data rate values are calculated depending on the determined transmission parameters from the virtual link adaptation. The potential data rate value is the value of the data rate which could or would be achieved on a specific shared physical channel with the channel quality which was the basis for the determination of the transmission parameters. Therefore for each service category information exists about which amount of data could be transmitted on each shared channel within the next PHY data frame or frames. The potential data rate values are also calculated per combination of service category and shared physical channel. If data from M service categories is transmitted over N PHY channels, a complete set of potential data rate values would comprise M·N values.

The potential data rates may also depend on the fill state or status of the corresponding buffers. In particular, a low amount of data belonging to the regarded service category and residing in the buffer could be insufficient to fill a complete data frame at a high data rate. As each shared channel transmits only data from one service category within one frame, the actual data rate which can be achieved during the next physical frame cannot be higher than the amount of data of this service category waiting for transmission.

In step S1304, priority values are calculated from the potential data rate values, at least for some of the combinations of service category and shared physical channel. Again, a complete set comprises M·N values for M service categories and N channels. The priority values may additionally depend on parameters associated with the service category for which the priority value is calculated. Such parameters may comprise a required or actual data rate, a required or actual packet error rate or a required or actual packet delay. A required value may be specified according to QoS requirements of the QoS class to which the service category belongs. It may also depend on the specific user, for example according to the type of contract between user and provider. An actual value is to be understood as a value determined from the transmission of data of the respective service category in the recent past. For example, if a particular service category has to transmit a high amount of data and has not been considered accordingly in the scheduling in the preceding frames, the actual packet delay will be high, and consequently the priority value will be higher than before. In the given example, the buffer for this service category might also be well filled. This packet buffer status may also be considered in the calculation of the priority value. Another buffer status parameter might be for example a time to live of the packets in the buffer belonging to this service category. If the buffer contains packets of this service category which have to be delivered in the near future, the priority value for this service category should correspondingly be higher.

In calculating the priority values, there may be different algorithms, and the algorithm used may be selected depending on the service category. For example, the calculation may depend on the requirements of the QoS class to which the service category belongs. Furthermore it may depend on the type of contract between the user who runs the services, and the network provider.

In step S 1305, scheduling metrics are calculated based on the priority values. According to these scheduling metrics, service categories are determined which will be served during the next physical frame, and the mapping of service categories to shared physical channels is determined (step S1306). Then data packets from the selected service categories are multiplexed into data blocks in HARQ protocol handling/packet multiplexing unit 908, and the blocks are handed to the PHY processing unit 910 of the respective shared physical channel which is also informed about the transmission parameters determined in the virtual link adaptation for the combination of this service category and this shared physical channel. PHY processing will use these parameters for the real transmission of the data.

An exemplary result of such scheduling and mapping is depicted in FIG. 5. The PHY Data Block 513 on channel 505 contains only packets 512 belonging to service 306 and packets 513 belonging to service 308. Both services 306 and 308 belong to QoS class 3 and are running on the second mobile station 302. All data packets for channel 505 within frame 500 are combined to PHY Data Block 514.

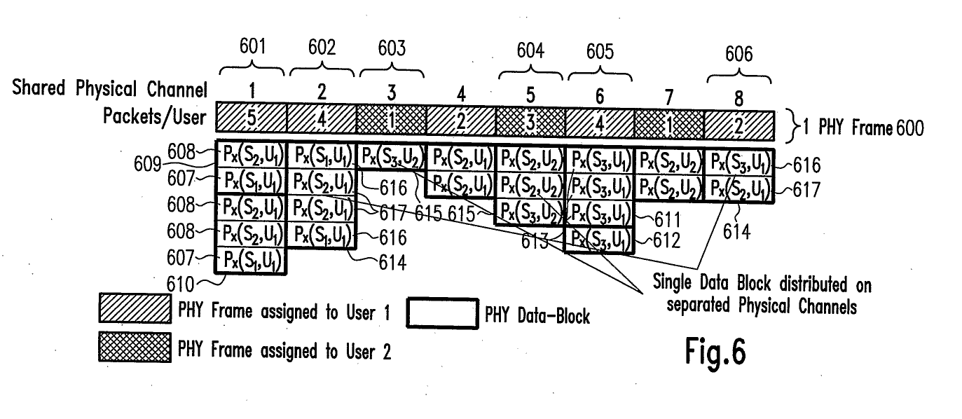

Although all data packets are drawn with identical size in FIGS. 4, 5 and 6 as a simplified example, they will generally have variable size, and the method according to the invention is applicable without restriction to packets having variable size.

Although a communication system could in a special case comprise only one shared physical channel for data transmission, there will usually be a plurality of shared physical channels available. The method according to the invention is advantageously applied either to all of the shared physical channels or to a subset of all channels. The remaining shared physical channels and the dedicated physical channels would then be mapped according to prior art.

As mentioned above, the description refers to downlink transmission as illustrative example of the disclosed principle.

In a further alternative, PHY processing 910 comprises a power control functionality. Adapting the transmission power to the QoS requirement of the QoS class allows particularly efficient use of the total transmission capacity.

For the priority calculation in unit 911, additional information on the individual packets (e.g. time stamp, waiting time, time-to-live) needs to be available, which is usually contained in the packet header. I.e. data packets as communicated in a system according to this invention may be Internet Protocol (IP), Transmission Control Protocol (TCP), User Datagram Protocol (UDP), RTP (Real-Time Protocol) packets or any other (proprietary) protocol, according to which the packets contain relevant information. With this information, unit 911 may advantageously determine the delay status (QoS status) for each packet, e.g. according to a time stamp, waiting time, time-to-live, time left for in-time delivery, etc. The virtual link adaptation in unit 912 may adjust the MCS “aggressiveness” and HARQ parameters, i.e. transmission parameters, not only according to the required QoS, but dynamically also to the actual QoS status of the data packet(s) contained in the PHY data block to be scheduled. For example, if packets belonging to a time critical service like video conference have encountered a rather big delay from their origin (the terminal of the opposite party) up to the scheduler, the MCS selection will be even more conservative and/or the HARQ scheme will be chosen as strong as possible to avoid any re-transmission. If such packets have travelled through the rest of the network rather quickly, a slightly more aggressive MCS selection might be allowable.

As one PHY Data Block usually contains packets from different services belonging to the same QoS class, the requirement of the most critical service is preferably applied to the whole QoS class, i.e. transmission parameters for a given frame in a given channel for a given PHY Data Block are adjusted such that the requirement for the service with the most critical actual QoS status can be met.

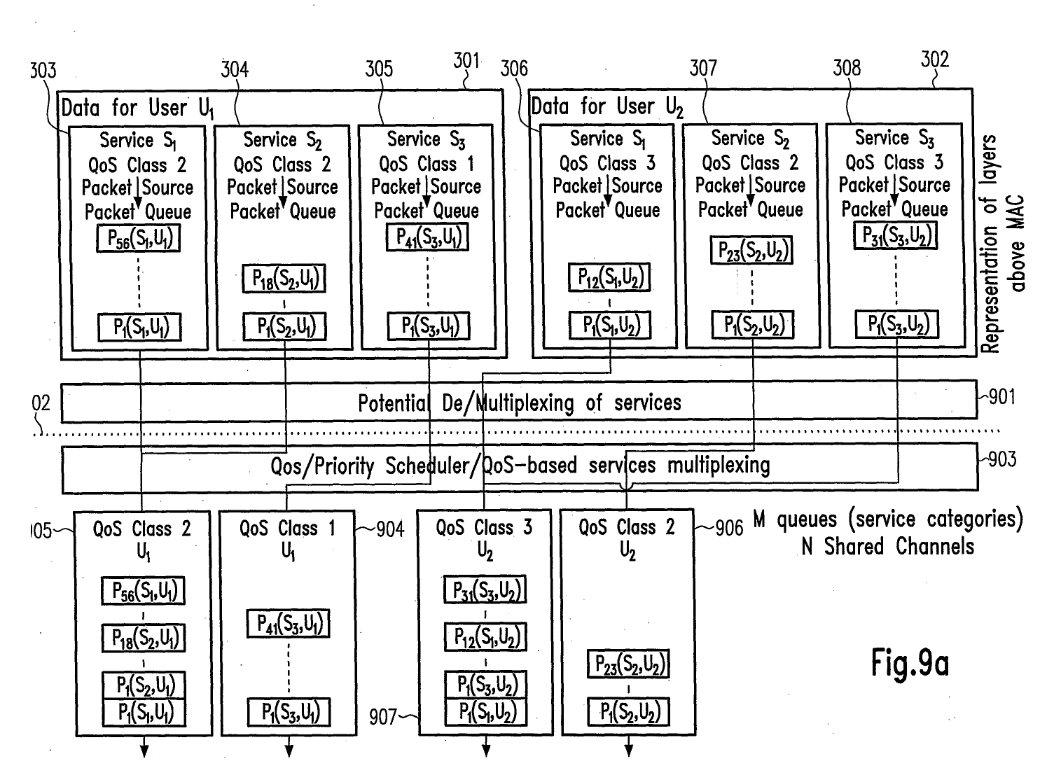

In the example shown FIG. 5, each channel contains only one data block per frame. For example, channel 501 contains data block 511, channel 502 contains data block 515 and so on. A case where some of the channels contain more than one PHY data block, is illustrated in FIG. 6. For example, channel 601 contains data blocks 609 and 610 and channel 605 contains data blocks 611 and 612. In this case depending on the system parameters and signalling two solutions are possible/preferable:
all PHY data blocks mapped onto one PHY channel within one PHY frame must contain data packets from services belonging to the same category. This is the case when the system is defined such that one set of transmission parameters is defined per shared physical channel (for possibly multiple PHY data blocks). As an illustrative example, both data blocks 609 and 610 contain data packets 607 belonging to service 303 and data packets 608 belonging to service 304, both running on the first mobile station in FIGS. 3 and 9-12 and both belonging to QoS class 2. Blocks 611 and 612 both contain data packets 613 belonging to service 305 running on the first mobile station.
PHY data blocks mapped onto one PHY channel within one PHY frame may contain data packets from services belonging to different categories, where of course each PHY Data Block must contain only services belonging to the same category. This is the case when the system is defined such that one set of transmission parameters is defined per PHY Data Block, i.e. multiple sets of transmission parameters may be defined per shared physical channel.

In all cases shown in FIGS. 5 and 6, a PHY data block must not contain data from different services belonging to different service categories.

On the other hand, one single data block may be distributed on multiple shared PHY channels. In FIG. 6, data block 614 is distributed between shared PHY channels 602 and 606, and data block 615 is distributed between channels 603 and 604.

Although there may be a fixed mapping of a certain service category to a shared physical channel over multiple PHY frames, this will generally not always be the case.

The time duration of the frames is preferably fixed, but it might also vary from one frame to the next. As the data rate is frequently changed by the MCS, two frames are likely to contain a different amount of data, although having the same time duration.

Referring back to FIG. 9-12, the first mobile station (301) is running three services S₁ (303), S₂ (304) and S₃ (305). S1 and S2 belong to the same QoS class—QoS class 2—and S3 belongs to a different QoS class—QoS class 1. As an illustrative example, service 303 may be a file transfer service (e.g. FTP), service 304 a HTTP download and service 305 may be a videoconference service. Hence, according to Table 3 the QoS requirements for S₁ (303) would be a strictly low service packet loss rate (e.g. 10⁻⁸) and a relaxed packet delay, usually in the order of several seconds. In contrast, S₃ (305) could tolerate a relatively large packet loss rate, such as 10⁻³, but has a strict delay requirement (e.g. 40-90 ms).

In case of a prior art system (FIG. 4), data packets from both services could be mapped onto the same PHY Data Block/shared physical channel. For example, channel 401 contains data packets 409 and 410 belonging to service 303, data packet 411 belonging to service 304 and data packets 412 and 413 belonging to service 305. Since the MCS selection is performed either per PHY Data Block or per shared physical channel, the service packet loss rates (residual PHY error rate) and the packet delays for packets of both services will be correlated and cannot be controlled independently. As HARQ retransmissions are performed on PHY Data Block basis (i.e. always whole PHY Data Blocks are retransmitted), the following problems can occur:
“Aggressive” MCS selection (at least for the initial transmission) and low number of maximal HARQ retransmissions: The strict packet loss rate requirement for QoS class 2 (file transfer) might not be matched, since the residual PHY error-rate (service packet loss-rate) will be too large.
“Aggressive” MCS selection (at least for the initial transmission) and high number of maximal HARQ retransmissions: The strict packet loss rate requirement for QoS class 2 might be matched, but the strict delay requirement of QoS class 1 might not be matched. I.e. service packets 412 and 413 from service 305 arrive too late at the receiver and packets are discarded by the application. This leads to inefficient use of air interface resources, since these packets, which have been re-transmitted several times, are useless for the application as they arrive too late.
“Non Aggressive” MCS selection: The strict packet loss rate requirement for QoS class 2 (file transfer) could be matched, but air interface resources might not be utilized efficiently. An “aggressive” MCS selection usually employs modulation schemes with higher data rates yielding a better air-interface throughput efficiency at the expense of increased delay.

In case of a system according to FIG. 5, channel 502 (PHY Data Block 511) carries only data packets 516 of service 303 and data packets 517 of service 304, both belonging to QoS class 2. Channel 506 (PHY data block 519) carries only packets 518 belonging to service 305. Therefore the MCS and HARQ parameter selection for a PHY Channel/Data Block within one frame can be performed according the requirements of the QoS class of the services, since each channel carries data for services of the same QoS class within one PHY frame. An advantageous setting of parameters is the following:
Delay critical QoS class with strict packet loss requirement:
Very “conservative” MCS selection, low/medium number of maximum retransmissions, if possible strong HARQ scheme
Delay critical QoS class with loose packet loss requirement:
“Conservative” MCS selection, low number of maximum retransmissions, weak HARQ scheme is sufficient
Delay uncritical QoS class with strict packet loss requirement:
“Aggressive” MCS selection, high number of maximum retransmissions, if possible strong HARQ scheme
Delay uncritical QoS class with loose packet loss requirement:
Very “aggressive” MCS selection, low number of maximum retransmissions, weak HARQ scheme is sufficient

As explained above, the overall MAC and physical layer QoS control depends on the combined operation of the MCS selection, the HARQ parameters/scheme and the MAC/PHY scheduler. For the examples above, the channel 502 carrying data packets belonging to service 303 (file transfer) and service 304 (HTTP download), both belonging to QoS class 2, should have an “aggressive” MCS setting and a strong HARQ scheme with a high number of maximum re-transmissions. Channel 506 carrying data packets for service 305 (video conferencing) belonging to QoS class 1 should have a “conservative” MCS setting and a less strong HARQ scheme with lower number of maximum re-transmissions would be sufficient.

In some systems only a single HARQ scheme is available or for configuration reasons only a single HARQ scheme is configured, i.e. the HARQ settings are solely controlled over the maximum number of retransmissions.

The definition of a shared physical channel may either vary on a frame-by-frame basis, may be configured on a semi-static basis or may be fixed. E.g. in an OFDMA, OFCDMA or MC-CMDA system a shared physical channel may contain one or multiple subcarrier-blocks, which in turn usually contain several subcarriers. The subcarriers, out of which a subcarrier-block is constructed, may be adjacent or distributed over the available bandwidth. In case multiple shared physical channels are configured, the shared physical channels may contain a varying number of subcarrier-blocks

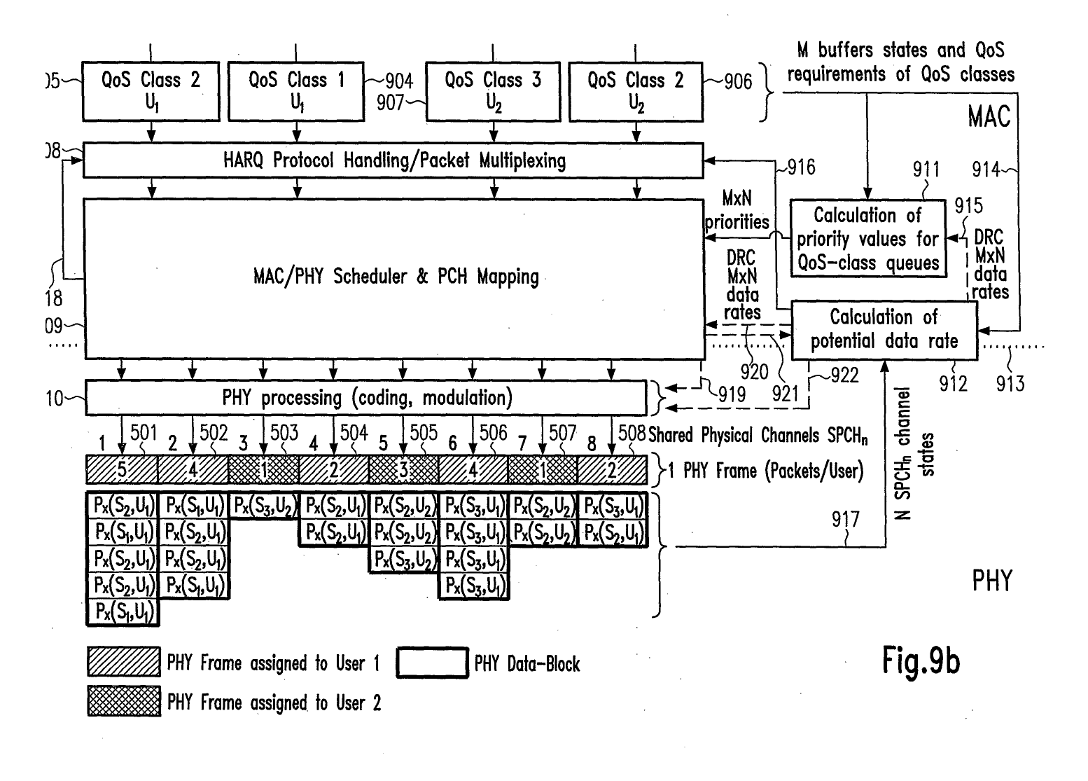

Referring now to FIG. 7, an advantageous possibility is shown how to avoid loss of transmission capacity caused by a mismatch of packet size and physical frame size. In FIG. 7 one shared physical channel 701 is shown as an illustrative example. 702, 703 and 704 are three frames. Packets 705 and 706 belong to a first QoS class and packets 709 and 710 to a second QoS class. Services belonging to both QoS classes might run on the same mobile station or services belonging to the first QoS class are run on a different mobile station than services belonging to the second QoS class. Packet 705 is for example mapped onto frame 702 in channel 701. As it contains less data than can be transmitted (according to the MCS selection) during frame 702, there is some transmission capacity remaining. In order to allow individual adaptation of the transmission parameters of shared physical channel 701 during frame 702 to the QoS requirements of the first QoS class, no packets of services belonging to a different QoS class should be mapped into the same frame. However, the next packet 706 is too big for the remaining space in frame 702. The solution shown here is to segment packet 706 into two (or possibly more) smaller segments, here 707 and 708, so that a segment 707 fills the remaining space of frame 702.

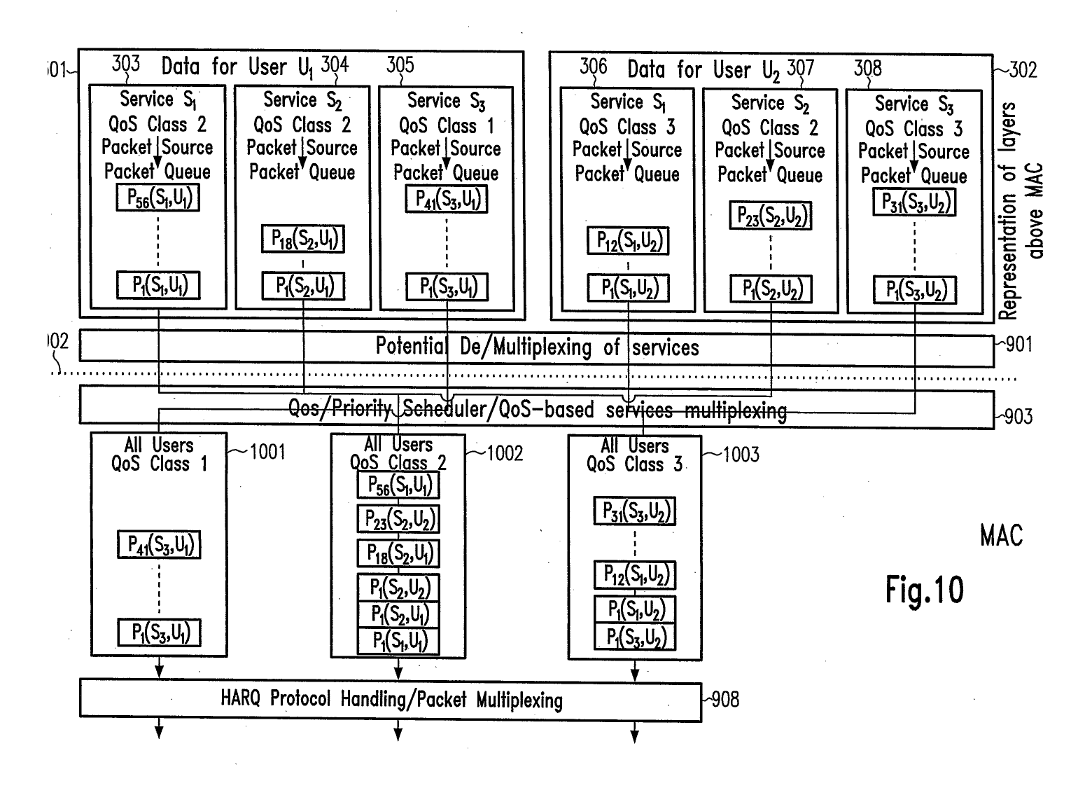

In a further advantageous embodiment, and as explained above in conjunction with packet header information, the QoS class specific MCS and HARQ parameter selection may not only be adapted to the requirement of the respective QoS class of the data transmitted, but additionally or solely adapted dynamically to the actual QoS status of packets or services belonging to the QoS classes multiplexed onto a shared physical channel, such as the actual delay status or the monitored current loss rate. A corresponding system is depicted in FIG. 8. Data transmitter 801 is equipped with a sending system shown in FIG. 3 or 9-12, particularly comprising a Link Adaptation unit 313, 910 and a Packet Multiplexing unit 310, 908 executing HARQ Protocol Handling. Data transmitter 801 further comprises an RF transmitter with antenna 804. Data is transmitted over a shared physical channel of an RF link 805 to a reception unit 806 of a data receiver 802. Reception unit 806 also comprises a QoS monitoring unit 807 monitoring values of QoS parameters like actual packet delay or actual packet loss rate. This information is transmitted over sending system 808, a second RF link 809 and reception unit 810 back to the Link Adaptation unit 313, 910 and HARQ Protocol Handling unit 310, 908 which can react accordingly. For example, when the residual packet loss rate is too high, the maximum number of re-transmissions can be increased, the MCS “aggressiveness” can be reduced or the transmission power increased. When the actual packet delay is higher than allowed by the service for which the data is designated, the Link Adaptation unit might for example select a less aggressive MCS or reduce the maximum number of re-transmissions of the HARQ algorithm.

As explained above, one channel usually contains packets from different services belonging to the same QoS class. Therefore the requirement of the service in most critical state preferably defines the transmission parameters. In the case that information about more than one aspect of the actual QoS status of packets is available, such as actual delay status plus actual loss rate, it is advantageous to define rules for assessing, which aspect is more critical. For example, depending on the QoS class, a critical delay status may override a critical loss rate for time critical services and a critical loss rate may override a critical delay status for services like file download. Another possibility would be to define limits for each aspect, possibly again depending on the respective QoS class. Then, the most critical service would be the service, which comes closest to any of the limits. A third possibility would be to define a combined QoS metric, which is a weighted combination of the different actual QoS states (delay, loss rate, etc.) of the individual services. The most critical service would then be the service maximizing/minimizing a combined QoS status metric. An alternative approach would be to look for the most critical service for each QoS aspect separately and adjust a plurality of transmission parameters depending on the respective most critical value of each aspect.

In a further advantageous embodiment the dynamic adaptation of the transmission parameters can also be performed without monitoring the QoS status at the receiver. Here, simply the transmitter 801 monitors e.g. the delay and packet loss rate statistics by processing the received HARQ ACK/NACK signals received from the data receiver 802.

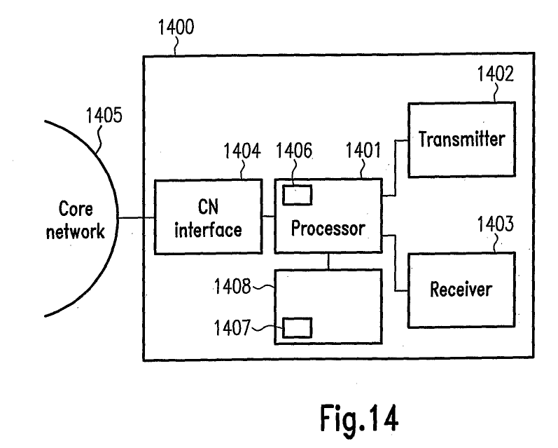

FIG. 14 illustrates the structure of a base station 1400 in which the method described above can be utilized. It comprises a processor 1401 which is configured for handling data, carrying out protocol functions and controlling the components of the base station. It may comprise one or more programmable microprocessors or microcontrollers together with memory for storing data and instructions. Instructions which cause the processor to carry out the methods according to the present invention may be stored in non-volatile semiconductor memory 1406 like read-only memory, programmable read only memory, flash memory and so on. Additionally it may be stored onto other computer-readable media 1407 such as magnetic disk, magnetic tape and optical disk, for download into the non-volatile memory 1406 of processor 1401, using an appropriate reader 1408. Processor 1401 may also comprise hardware logic, which may be fixed or field programmable. The described methods or parts thereof may also be executed in such hardware logic.

Base station 1400 also comprises a transmitter 1402 and a receiver 1403 for establishing a wireless connection to a mobile station, and a network interface 1404 for connecting it, directly or via other devices (not shown), with the core network 1405 of the wireless network.

The method according to the present invention advantageously provides the possibility to adapt the transmission parameters of physical channels individually to the required Quality of Service of the QoS class to which data transmitted over the channel belongs. Joint physical mapping and QoS mapping advantageously allows to adapt scheduling and mapping to the channel quality, such that data can be transmitted on the physical channel which is best suited for its QoS requirements. Furthermore the method according to the present invention allows to perform the scheduling based on the state of the packet buffer(s). This allows to better fulfill the QoS requirements. A further advantage of the method according to the present invention is that the transmission capacity of the physical channel can be economically utilized. Another advantage of the present invention is that transmission data rate and error rate can be improved by mapping data for a specific user to a channel which has a good transmission quality for this particular user.

1-21. (canceled)

22. Method for optimizing a quality of service in a wireless communication system transmitting data packets in time intervals of frames over at least one shared physical channel, wherein services are categorized into Quality of Service classes according to Quality of Service requirements associated with said services, and said data packets are assigned to service categories, wherein to at least a part of the service categories only packets are assigned exclusively belonging to services associated with one user or user group and exclusively belonging to one of said Quality of Service classes, comprising the steps of:
a) calculating scheduling metrics, based on information about said packets, said service categories and/or said at least one shared physical channel; and
b) deciding, based upon the scheduling metrics, which of said service categories is to be served next and deciding, based upon the scheduling metrics, about a mapping of service categories to shared physical channels.

23. The method according to claim 22, further comprising the step c) of calculating priority values for at least a part of the service categories as basis for said scheduling metrics.

24. The method according to claim 23, wherein the priority values are calculated based on at least one item out of a list consisting of a required data rate, an actual data rate, a required packet error rate, an actual packet error rate, a required delay, an actual delay status, a fixed value assigned to a quality of service class or a fixed value assigned to a user, wherein the at least one item is associated with the service category for which the priority value is calculated.

25. The method according to claim 23, wherein at least two different algorithms are used for calculating the priority values, based on the service category for which the priority value is calculated.

26. The method of claim 23, wherein packets of M service categories are mapped to N shared physical channels, wherein the step c) (S1304) comprises calculating M·N priority values, one for each combination of service category and shared physical channel.

27. The method of claim 23, further comprising a step d) of calculating potential data rate values for at least a part of the combinations of service category and shared physical channel, wherein step c) is based on results of step d).

28. The method of claim 27, wherein packets of M service categories are mapped to N shared physical channels, and the step d) comprises calculating M·N potential data rate values, one for each combination of service category and shared physical channel.

29. The method according to claim 28, further comprising a step e) of determining virtual link adaptation parameters as basis for step d).

30. The method according to claim 29, wherein said virtual link adaptation parameters comprise at least one out of a list consisting of a forward error correction rate, a forward error correction scheme, a modulation scheme, power control parameters, a scheme for hybrid automatic repeat request and a redundancy version.

31. The method according to claim 29, wherein said virtual link adaptation parameters are determined in step e) based on channel quality information of a physical channel.

32. The method according to claim 31, wherein said channel quality information comprises a reception field strength, a transmission loss value or a signal to noise ratio value.

33. The method according to claim 31, wherein at least a part of said channel quality information is received from a recipient of data sent on said physical channel.

34. The method according to claim 29, wherein in step e) virtual link adaptation parameters are determined depending on the Quality of Service class to which packets within the service category, for which the potential data rate value is calculated, belong to.

35. The method according to claim 29, wherein said potential data rates are calculated based on a status of a packet buffer for the service category for which the potential data rates are calculated.

36. The method according to claim 22, further comprising the step of multiplexing packets into queues according to the service categories to which they are assigned.

37. A computer-readable storage medium having stored thereon instructions that, when executed in a processor of a base station of a wireless communication system, causes the processor to perform the method of claim 22.

38. A base station for a wireless communication system, comprising
a network interface, connecting it to a core network of said wireless communication system;
wireless transmission means; and
a processor for controlling said transmission means, and for transmitting data packets in time intervals of frames over at least one shared physical channel of said transmission means, wherein services are categorized into Quality of Service classes according to quality of service requirements associated with said services, and said data packets are assigned to service categories, wherein to at least a part of the service categories only packets are assigned exclusively belonging to services associated with one user or user group and exclusively belonging to one of said Quality of Service classes, wherein said processor is configured:
to calculate scheduling metrics, based on information about said packets, said service categories and/or said at least one shared physical channel; and
to decide, based upon the scheduling metrics, which of said service categories is to be served next.

39. The base station according to claim 38, wherein said processor is further configured to calculate priority values for at least a part of the service categories as basis for said scheduling metrics.

40. The base station according to claim 39, wherein said processor is further configured to calculate potential data rate values for at least a part of the combinations of service category and shared physical channel and to use said potential data rate values as basis for said calculation of said priority values.

41. The base station according to claim 40, wherein said processor is further configured to determine virtual link adaptation parameters as basis for said calculation of said potential data rate values.

42. The base station according to claim 38, wherein said processor is further configured to multiplex packets into queues according to the service categories to which they are assigned.

43. A wireless communication system, comprising at least one base station according to claim 38.
